(19) United States
(12) Patent Application Publication
(10) Pub. No.: US 2004/0093802 A1
(43) Pub. Date: May 20, 2004

(54) Abrasive, and abrasive manufacturing method and device

(76) Inventor: Tokihiro Shimura, Aomori-ken (JP)

Correspondence Address: INTELLECTUAL PROPERTY / TECHNOLOGY LAW, PO BOX 14329, RESEARCH TRIANGLE PARK, NC, 27709, US

(21) Appl. No.: 10/690,073

(22) Filed: Oct. 21, 2003

(30) Foreign Application Priority Data
Oct. 28, 2002 (JP) 2002-313341

(51) Int. Cl. C09K 3/14

(52) U.S. Cl. 51/293; 51/307; 51/308; 51/309

(57) ABSTRACT

The present invention provides an abrasive which can prevent any change in its quality, and which can also grind a work piece in a short time in a manner that achieves high quality and high yields, as well as improves a blast effect and productivity in a blast step. This invention also provides an abrasive manufacturing method and device capable of preventing the existence of agglomerated particles and improving the blast effect and the productivity in the blast step. Molten metal M contained in a tundish 100, which comprises an ejecting nozzle 110, is heated by a heating coil 120 and is then caused to eject from the ejecting nozzle 110. Subsequently, a high-pressure fluid F is ejected onto the molten metal M in a manner such that the ejected high-pressure fluid F will form a generally conical shape, which converges downwards and whose vertex is formed at an angle ranging between not less than 10 degrees and less than 30 degrees, and will surround the molten metal M, thereby powdering the molten metal M and manufacturing the abrasive.

### BACKGROUND

The present invention relates to an abrasive which is used to grind a work piece, and this invention also relates to an abrasive manufacturing method and device.

A blast technique for processing an object by atomizing an abrasive has been utilized for various purposes such as satin finishing of the surface of a work piece, cleaning treatment including iron stain removal, shot peening treatment for improving mechanical strength by shooting abrasives against a metal surface, or engraving processing for stones or the like. With recent improvements in blast devices and progress in masking techniques, it has become possible to perform precision processing in the order of microns. The blast technique is being used in an increasing number of cases, for example, for precision boring, precision cutting, and precision graving for substrates such as silicon wafers.

Moreover, such precision processing can be applied also in the field of sintered components. Specifically, although it has been difficult in the past due to technical and cost barriers, it is now possible to manufacture a component of the shape having complicated and precise patterned indented surfaces (or openings), by molding ceramic powder or metal powder, or even glass powder, for example, and then forming a resist pattern on the surface of the obtained green part and graving the green part by means of blasting, and finally sintering the obtained object.

Furthermore, again although it has been normally difficult in the past due to technical and cost barriers, it is now possible to manufacture a component of the shape having complicated, precise and very sharp patterned indented surfaces (or openings) by laminating over a substrate made of ceramic, metal or glass, for example, a paste form of fine particles made of the same material as that of the substrate, and then forming a resist pattern by using a photosensitive film, and graving the resist pattern to a depth to reach the substrate, and finally sintering the obtained object in order to integrate the substrate with the paste layer.

General examples of an abrasive used for sand blasting include alumina sand, silicon carbide powder, glass beads, calcium carbonate, and metal powder.

Abrasives for precision grinding are described in, for example, Japanese Patent Laid-Open (Kokai) Publication No. 2001-9727 and Japanese Patent Laid-Open (Kokai) Publication No. 2001-122644.

The abrasive (or polishing material) described in the Japanese Patent Laid-Open (Kokai) Publication No. 2001-9727 is composed of inorganic powder that meets all the following conditions (1) to (5):

| | | | |
|---|---|---|---|
| (1) | 10 | A | 0.8C |
| (2) | 0.03C | B | 0.5C |
| (3) | 50 | C | 800 |
| (4) | 30 | D | 95 |
| (5) | E₂ − 3.5 | E₁ | E₂ − 0.5 |

A: maximum particle size (μm) of the abrasive
B: average particle diameter (μm) of the abrasive
C: partition with d₁ + ground groove width d₂ (μm) at processing pitch
D: an index (%) representing indeterminate forms of particles and indicating an area ratio of a particle projected area to a circumcircle
E₁: Mohs hardness of the abrasive
E₁: lower Mohs hardness of either the substrate or an electrode

As the abrasive, any inorganic particle powder, whether natural or synthetic, may be used. The above patent publication describes that preferred examples of natural inorganic particle powder are limestone, barite and gypsum, and preferred examples of synthetic inorganic particle powder are calcium carbonate, barium sulfate and calcium sulfate.

The Japanese Patent Laid-Open (Kokai) Publication No. 2001-122644 discloses a technique to grind low-melting glass using an abrasive which contains not less than 90% metal powder.

Metal powder is generally manufactured by a water or gas atomizing method, or a mechanical pulverization method, or a chemical method such as electrolysis. Regarding the chemical method among these methods, the type of raw material for the abrasive is limited to pure metal only, and therefore, it is difficult to control the physical properties of the abrasive. Concerning the grinding method, it is difficult to obtain fine particles and entails high cost. Therefore, the atomizing method is appropriate as the method for manufacturing the abrasive made of the metal powder.

When the water atomizing method is employed, molten metal that is obtained by melting desired metal or metal alloy in, for example, an induction furnace is poured into a tundish positioned above an atomizer, and this molten metal is caused to eject (or supply) from an ejecting nozzle at the bottom of the tundish, into the atomizer. This atomizer atomizes a high-pressure fluid (such as water) onto the molten metal ejected from the ejecting nozzle, thereby powdering the molten metal and obtaining metal powder.

This high-pressure fluid atomizing method is classified into, for example, V-type atomization or cone-type atomization according to the geometric shape of the high-pressure fluid atomized onto the molten metal. For example, regarding the cone-type atomization in which the high-pressure fluid is ejected onto the molten metal in such a manner that the high-pressure fluid will form a generally conical shape, which converges downwards, and will surround the molten metal, at an angle β (water jet angle) of a vertex of the high-pressure fluid ejected in the generally conical shape which is set between 30 degrees and 60 degrees (see FIG. 6).

However, since the abrasive (or polishing material) described in the Japanese Patent Laid-Open (Kokai) Publication No. 2001-9727 has a small gravity, its collision energy is low and, therefore, its grinding power is also low. Accordingly, there are disadvantages such as requiring a long time for processing and decreased productivity.

Moreover, since the particles of the abrasive (or polishing material) are brittle, the ejection (or blasting) breaks the particles, thereby changing the quality of the particles. So, recycling of such abrasive may lead to the unevenness of the quality of the work piece.

Furthermore, since the hardness of the particles such as alumina sand, silicon carbide powder, or glass beads is high, there is the fear of damaging objects, such as a masking or a substrate, other than the target to be ground at the time of blasting. Particularly if glass is used as the substrate, the damage may cause problems such as deterioration of surface roughness, reduction of strength, and decreased transparency.

Regarding calcium carbonate, its hardness is low. However, since it is produced by pulverizing natural limestone, the obtained calcium carbonate contains trace amounts of impurities. Since these impurities include, for example, a hard substance such as silicon dioxide, as in the case of alumina sand or glass beads, there is the fear of damaging objects other than the target to be ground.

On the other hand, as disclosed in the Japanese Patent Laid-Open (Kokai) Publication No. 2001-122644, the metal powder has the advantage of being recyclable. However, there are possibilities that heat generation caused by the collision energy of the blasting may lead to oxidation and discoloring of the abrasive, and the changed color of the abrasive may be attached to (or the oxide may be attached to) the work piece, or that scales generated by oxidation may peel off the abrasive. In some cases, there is a possibility of discoloring or agglomeration due to generation of rust while the abrasive is recycled. This, of course, is dependent on the level of moisture in the air. In addition, the discoloring or agglomeration may be caused by phenomena such as when the air carried in the blast device compresses or expands due to changes of the cross-sectional area of a passage, thereby causing moisture condensation, or when heat generation due to blasting causes moisture condensation.

In a case when the abrasive is comprised of components whose hardness is extremely high, there is the fear of damaging objects other than the target to be ground.

Moreover, when the abrasive is carried through the passage in the blast device, the particles of the abrasive may make contact with each other, thereby generating static electricity and causing these particles to agglomerate. If this agglomeration occurs, the ejection amount of the abrasive ejected from the nozzle of the blast device becomes unstable and this may result in defective grinding.

Particularly for the metal powder manufactured by the water atomizing method, many secondary particles of different shapes, which are generated when a plurality of primary particles weld together, may exist depending on atomization conditions. In addition, depending on the components, the particles may become elongated shapes, instead of spherical. Therefore, the fluidity of the particles in the blast device worsens, thereby decreasing the productivity of the blast step and the stability of quality.

Furthermore, if this metal powder is used as an abrasive (or shot blast material), the secondary particles divide into fine particles of 10 μm or less, thereby reducing blast efficiency.

### SUMMARY

The present invention aims to solve the above-described conventional problems. It is an object of this invention to provide an abrasive which can prevent any change in its quality, and which can grind a work piece in a short time in a manner that achieves high quality and high yields.

It is another object of this invention to provide an abrasive manufacturing method which can prevent the existence of secondary particles by manufacturing metal powder of single grains, and which can improve a blast effect and productivity in a blast step.

It is still another object of this invention to provide an abrasive manufacturing device which can produce single grains, prevent the existence of secondary particles, and improve the blast effect and the productivity in the blast step.

It is a further object of this invention to provide an abrasive which can be produced as single grains, prevent the existence of secondary particles, and improve the blast effect and the productivity in the blast step.

In order to achieve these objects, the present invention provides an abrasive ejected onto a work piece to grind and process the work piece, the abrasive being composed of an inorganic powder that meets all the following conditions: (1) its true specific gravity is 4 g/cm³ or more; (2) its average particle diameter is from 5 μm to 50 μm inclusive; (3) its maximum particle size is 100 μm or less; and (4) its hardness (HMV) is from 110 to 340 inclusive.

Since the abrasive composed in the above-described manner has a high specific gravity (true specific gravity 4 g/cm³), it is possible to obtain excellent grinding power. Its average particle diameter is set within the range that can realize excellent grinding power (5 μm average particle diameter 50 μm). Accordingly, it is possible to shorten the time required to process a work piece and to improve productivity.

It is desirable that the average particle diameter of the inorganic powder be between 10 μm and 30 μm inclusive.

If the hardness of the abrasive is low, good grinding power cannot be expected. On the other hand, if the hardness of the abrasive is too high, there is a tendency to damage parts or objects other than the target to be ground. Therefore, for this invention, the hardness is set to 110 hardness (HMV) 340.

Moreover, by setting the maximum particle size of the abrasive of this invention to 100 μm or less, it is possible to obtain more suitable grinding power and to prevent narrow crevices having a width of about 150 μm from being clogged with the abrasive when such crevices are being ground. Furthermore, it is desirable that the maximum particle size of the inorganic powder be 80 μm or less.

The inorganic powder can be composed of metal powder. If the inorganic powder is composed of metal powder having high toughness, it is further possible to prevent the particles from being destroyed by impact at the time of grinding.

The metal powder can be composed in such a manner that the principal component of the metal powder is iron or an iron-based alloy and the metal powder contains 0.1 wt % aluminum and 0.1 wt % titanium.

Concerning the metal powder composed in the above-described manner, the aluminum and titanium content is kept low. Accordingly, the increasing surface tension of the molten metal, which is a raw material of this metal powder, thereby promotes spheroidization of the metal powder particles. Therefore, it is possible to obtain excellent blast effect. In addition, the metal powder can contain not less than 8 wt % chromium and, therefore, it is possible to inhibit the generation of rust (or oxidation) and thereby maintain excellent blast effect. Moreover, since the metal powder can contain not more than 1.5 wt % boron, the surface tension increases, thereby promoting spheroidization of the obtained metal particles.

It is desirable that the tap density of the metal powder be set to between 4.3 g/cm³ and 4.8 g/cm³ inclusive. As the spheroidization of the metal particles and the creation of single grains of the metal particles progresses, the tap density becomes a larger value. In other words, if the particles are spherical and are single grains which are separated from each other, a filling factor increases, thereby increasing the tap density. By setting the tap density between 4.3 g/cm³ and 4.8 g/cm³ inclusive, it is possible to make the abrasive more suitable for blasting.

The abrasive of this invention can be composed in such a manner that 0.01 wt % to 5 wt % of a substance providing fluidity and resistance to moisture absorption is mixed in 100 wt % of the inorganic powder.

Moreover, the abrasive of this invention can be composed in such a manner that a substance providing fluidity and resistance to moisture absorption is attached to a part of or the entire surface of the inorganic powder in the proportions of 0.01 wt % to 5 wt % of the substance to 100 wt % of the inorganic powder.

As described above, it is possible to prevent the abrasive (or inorganic powder) from agglomerating by mixing the substance providing fluidity and resistance to moisture absorption (hydrophobic property) into the inorganic powder, and by attaching the substance providing fluidity and resistance to moisture absorption to a part of or the entire surface of the inorganic powder. Accordingly, it is possible to stabilize the ejection amount of the abrasive and to prevent the generation of static electricity due to flow of the abrasive within the device when it is moved within the device. It is further possible to prevent changes of quality due to moisture absorption.

Examples of the substance for improving fluidity and moisture absorption include stearic acid or anhydrous silica particles.

Furthermore, since the hardness (HMV) of the abrasive of this invention is lower than that of a glass substrate, there is no damage to the substrate even when a glass paste layer formed on the glass substrate is ground.

This invention also provides an abrasive manufacturing method comprising the steps of: causing molten metal contained in a tundish including an ejecting nozzle to eject from the ejecting nozzle; and ejecting a high-pressure fluid onto the molten metal ejected from the ejecting nozzle in such a manner that the high-pressure fluid will form a generally conical shape, which converges downwards, and will surround the molten metal, thereby powdering the molten metal; wherein the angle of a vertex of the generally conical shape that is formed by ejection of the high-pressure fluid is set between not less than 10 degrees and less than 30 degrees.

This manufacturing method can secure a wider primary dispersion area of the molten metal as caused by the ejection of the high-pressure fluid than a conventional method. Accordingly, when the metal powder (or abrasive) is generated by the decompression effect of the ejected high-pressure fluid (water jet), it is possible to strengthen the diffusion of primary division particles and to prevent the obtained metal powder (or abrasive) from agglomerating.

It is desirable that the angle of a vertex of the generally conical shape that is formed by ejection of the high-pressure fluid be set between 15 degrees and 25 degrees inclusive, preferably to 20 degrees.

The abrasive manufacturing method according to this invention can further comprise the step of heating the tundish. This heating step can prevent the temperature of the ejected molten metal from decreasing. In other words, since immediately before the ejection of the high-pressure fluid, the high temperature of the molten metal can be maintained, it is possible to keep high surface tension of the molten metal and to promote the spheroidization of the metal powder particles which are obtained by primary division caused by ejection of the high-pressure fluid. As a result, it is possible to further prevent the obtained metal powder (or abrasive) from agglomerating.

It is desirable that the tundish be heated so that the temperature of the molten metal ejected from the ejecting nozzle will be between 1600 and 1700 inclusive, preferably from 1630 to 1680 inclusive.

It is also desirable in the abrasive manufacturing method according to this invention that as the molten metal, a raw material be used whose principal component is iron or an iron-based alloy, and to which no aluminum or titanium is added.

Concerning the raw material that contains the above-mentioned components, the content of aluminum and titanium, which are considered to inhibit the creation of single grains of the metal powder (or abrasive), is kept as 0.1 wt % or less, it is possible to promote the creation of single grains of the metal powder particles which are obtained by primary division caused by the ejection of the high-pressure fluid.

This invention also provides an abrasive manufacturing device comprising: a tundish for containing molten metal; an ejecting nozzle mounted on the tundish to cause the molten metal contained in the tundish to eject out; and an atomizing nozzle for ejecting a high-pressure fluid onto the molten metal ejected from the ejecting nozzle in such a manner that the high-pressure fluid will form a generally conical shape, which converges downwards, and will surround the molten metal; wherein the atomizing nozzle causes a high-pressure fluid to eject so that the angle of a vertex of the generally conical shape that is formed by ejection of the high-pressure fluid will be between not less than 10 degrees and less than 30 degrees.

The abrasive manufacturing device having the above-described structure can eject the high-pressure fluid in a manner such that a primary dispersion area of the molten metal caused by the ejection of the high-pressure fluid becomes wider than a conventional device. Accordingly, when the metal powder (or abrasive) is generated by the decompression effect of the ejected high-pressure fluid (or water jet), it is possible to strengthen the diffusion of primary division particles and to prevent the obtained metal powder (or abrasive) from agglomerating.

It is desirable that the atomizing nozzle should cause the high-pressure fluid to eject so that the angle of a vertex of the generally conical shape that is formed by ejection of the high-pressure fluid will be between 15 degrees to 25 degrees inclusive, preferably 20 degrees.

The abrasive manufacturing device according to this invention can further comprise a heater for heating the tundish. By providing this heater, it is possible to prevent the temperature of the ejected molten metal from decreasing. In other words, since immediately before the ejection of the high-pressure fluid, the high temperature of the molten metal can be maintained, it is possible to keep high surface tension of the molten metal and to promote the spheroidization of the metal powder particles which are obtained by primary division caused by ejection of the high-pressure fluid. As a result, it is possible to further prevent the obtained metal powder (or abrasive) from agglomerating.

The heater can heat the tundish so that the temperature of the molten metal ejected from the ejecting nozzle will be between 1600 and 1700 inclusive, preferably from 1630 to 1680 inclusive.

Moreover, this invention provides an abrasive manufactured by the above-described manufacturing method.

Furthermore, this invention provides an abrasive manufactured by the above-described manufacturing device.

### DESCRIPTION OF DRAWINGS

FIG. 1 is a perspective view of a work piece according to Embodiment 1 of the present invention.

FIG. 2 is a conceptual drawing of a vertical section of an abrasive manufacturing device according to Embodiment 2 of this invention.

FIG. 3 is a conceptual drawing of a high-pressure fluid ejected from an atomizer which is a component of the manufacturing device show in FIG. 2.

FIG. 4 is a microphotograph of an abrasive (or metal powder) manufactured by the manufacturing device and method according to Embodiment 2 of this invention.

FIG. 5 is a microphotograph of a conventional abrasive (or metal powder).

FIG. 6 is a conceptual drawing of a high-pressure fluid ejected from an atomizer which is a component of a conventional manufacturing device.

### DETAILED DESCRIPTION

An abrasive, an abrasive manufacturing method, and an abrasive manufacturing device according to embodiments of this invention are described below in detail. However, this invention is not limited by these embodiments.

(Embodiment 1)

Abrasives (Examples 1 to 5) having component values (wt %) as described in Table 1 were manufactured. For comparison purposes, abrasives (Comparisons 1 to 6) having component values (wt %) as described in Table 1 were also manufactured. For further comparison purposes, calcium carbonate (Comparison 7), glass beads (Comparison 8), and alumina (Comparison 9) were also prepared.

TABLE 1

| | | Component Values (wt %) | | | | | | | | | |
|---|---|---|---|---|---|---|---|---|---|---|---|
| | | C | Si | Mn | Cr | Ni | Mo | Al | Ti | B | Fe |
| Abrasives | Example 1 | 0.02 | 0.8 | 0.8 | 12.5 | — | — | — | — | — | Bal. |
| (Metal Powder) | Example 2 | 0.05 | 1.3 | 0.7 | 13.0 | — | — | — | — | — | Bal. |
| | Example 3 | 0.02 | 0.7 | 0.7 | 17.0 | 12.8 | 2.0 | — | — | — | Bal. |
| | Example 4 | 0.05 | 1.4 | 0.9 | 19.7 | — | — | — | — | — | Bal. |
| | Example 5 | 0.02 | 0.8 | 0.8 | 18.2 | 10.5 | — | — | — | 0.5 | Bal. |
| | Comparison 1 | 0.16 | 0.9 | 0.8 | 12.7 | — | — | — | — | — | Bal. |
| | Comparison 2 | 0.58 | 0.8 | 0.9 | 12.8 | — | — | — | — | — | Bal. |
| | Comparison 3 | 0.03 | 0.8 | 0.8 | 5.0 | 1.0 | — | — | — | — | Bal. |
| | Comparison 4 | 0.02 | 0.8 | 0.8 | 18.0 | 10.3 | — | 2.0 | — | — | Bal. |
| | Comparison 5 | 0.03 | 0.8 | 0.8 | 18.2 | 10.1 | — | — | 2.0 | — | Bal. |
| | Comparison 6 | 0.02 | 0.8 | 0.8 | 18.0 | 10.1 | — | 3.0 | 0.5 | — | Bal. |
| Calcium | Comparison 7 | — | — | — | — | — | — | — | — | — | — |
| Carbonate | | | | | | | | | | | |
| Glass Beads | Comparison 8 | — | — | — | — | — | — | — | — | — | — |
| Alumina | Comparison 9 | — | — | — | — | — | — | — | — | — | — |

Bal: Balance

Concerning Examples 1 to 5 and Comparisons 1 to 9, the hardness (HMV), true specific gravity (g/cm³), average particle diameter (μm), and maximum particle size (μm) were measured in a manner described below. Table 2 shows the results.

The hardness (HMV) was measured with Micro Vickers Hardness Scale (TYPE-M) made by SHIMAZU CORPORATION. Measurement was conducted with a load of 25 g, and the hardness was measured and indicated by finding an average value of 10 particles.

The true specific gravity was measured by a pycnometer method by using a commercially available pycnometer made of glass.

The average particle diameter and the maximum particle size were measured with Microtrack Particle Size Analyzer SRA7995 made by Nikkiso Co., Ltd.

The true density was measured by the pycnometer method by using Auto True Denser made by SEISHIN ENTERPRISE CO., LTD.

TABLE 2

| | | True | | |
|---|---|---|---|---|
| | | Specific | Average Particle | Maximum |
| | Hardness | Gravity | Diameter | Particle Size |
| | (HMV) | [g/cm³] | [μm] | [μm] |
| Example 1 | 241 | 7.7 | 20 | 70 |
| Example 2 | 310 | 7.7 | 20 | 70 |
| Example 3 | 146 | 8.0 | 20 | 70 |
| Example 4 | 250 | 7.4 | 20 | 70 |
| Example 5 | 290 | 7.8 | 20 | 70 |
| Comparison 1 | 510 | 7.7 | 20 | 70 |
| Comparison 2 | 506 | 7.7 | 20 | 70 |
| Comparison 3 | 220 | 7.8 | 20 | 130 |
| Comparison 4 | 150 | 7.8 | 20 | 70 |
| Comparison 5 | 155 | 7.8 | 20 | 70 |
| Comparison 6 | 147 | 7.8 | 20 | 70 |
| Comparison 7 | — | 2.8 | 19 | 75 |
| Comparison 8 | — | 2.5 | 20 | 60 |
| Comparison 9 | — | 30 | 20 | 50 |

Processing was conducted to dig a groove with a width of 100 μm in a glass paste formed over a glass substrate in the following manner.

(Groove-Forming Method)

The glass paste was applied with a coater over a square glass substrate (300 mm ×300 mm) (thickness: 5 mm), thereby forming a 200 μm paste layer. After the paste layer was dried, a photoresist (or dry film) was pasted onto the surface of the paste layer. The photoresist was exposed to ultraviolet radiation and development was then conducted, thereby forming a resist pattern (or mask) of a 100 μm wide mesh over the glass paste.

Subsequently, the substrate with the resist pattern formed thereon was set on the blast device, and every kind of abrasive for Examples 1 to 5 was used and the resist pattern was employed as the mask in order to grind the glass paste layer. This grinding was conducted by setting the blast device to the following conditions:

| | |
|---|---|
| Ejecting nozzle aperture: | 10 mm |
| Abrasive-ejecting pressure: | 1.5 kg/cm² |
| Abrasive-ejecting amount: | 15 g/min |
| Distance to the substrate: | 20 cm |

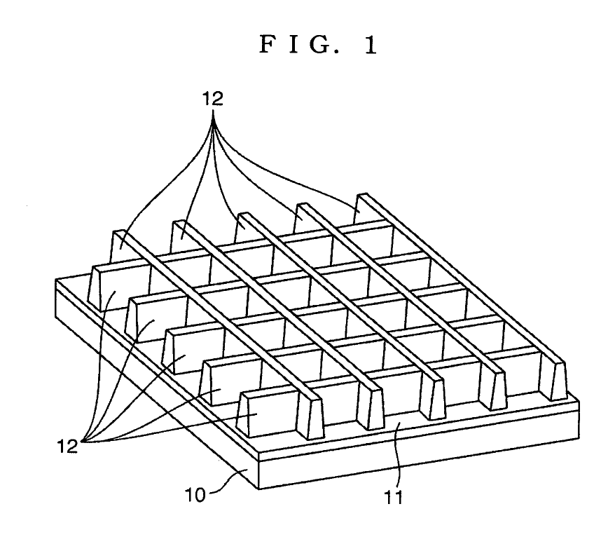

The ground paste material and the abrasive were removed by an air blow, and a solution (sodium hydroxide solution) was sprayed on the substrate to cause the photoresist to peel off. Subsequently, the substrate was sintered at a temperature of about 550, thereby forming mesh-like grooves 11 of narrow widths as shown in FIG. 1.

In FIG. 1, reference numeral 10 refers to the glass substrate, and reference numeral 11 refers to the grooves formed by grinding.

For comparison purposes, mesh-like grooves of narrow widths were formed by the method similar to that described above, except that the abrasives of Comparisons 1 to 9 were used.

Concerning partitions 12 defined by the respective grooves 11 formed by the above-described method, a ground amount per unit time, a damaged state of the substrate, a damaged state of the masking, a state of the grooves clogged with the abrasive, a destroyed state of the abrasive, and discoloring due to rust were evaluated by the following method.

The ground amount per unit time was obtained by measuring the weight of the ground glass paste, which was collected in a predetermined time, by using an electronic weighing machine.

Regarding the damaged state of the substrate, the damaged state of the masking, the state of the grooves clogged with the abrasive, and the destroyed state of the abrasive, visual observation was conducted with an electronic microscope and the evaluation was done according to the following standards:

No damage, clogging or destruction observed (good state);

Slight damage, clogging or destruction observed; or

Damage, clogging or destruction observed (bad state).

A test to examine discoloring due to rust was conducted by visual observation, according to the above-described standards, the results of discoloring after uniformly spreading each abrasive in a glass-made plate, spraying 10 cc distilled water over the abrasive, and leaving it at room temperature for 24 hours. After a heating test at a temperature of 550 for 30 minutes was conducted in the atmosphere for each abrasive, visual observation was conducted to evaluate the state of discoloring according to the above-described standards. Table 3 shows the results.

TABLE 3

| | Evaluation | | | | | |
|---|---|---|---|---|---|---|
| | Processing Amount | | | | | |
| | <0.5 Desired Value | Ground State | | | | |
| | (Ground Amount | Damage | Damage | Clogging | | |
| | per Unit Time: | to | to | in | Destruction | Discoloring |
| | Index) | Substrate | Masking | Grooves | of Abrasives | due to Rust |
| Example 1 | 1.0 | | | | | |
| Example 2 | 0.9 | | | | | |
| Example 3 | 1.0 | | | | | |
| Example 4 | 1.0 | | | | | |
| Example 5 | 1.0 | | | | | |
| Comparison 1 | 1.5 | | | | | |
| Comparison 2 | 1.5 | | | | | |
| Comparison 3 | 0.8 | | | | | x |
| Comparison 4 | 1.0 | | | | | |
| Comparison 5 | 1.0 | | | | | |
| Comparison 6 | 1.0 | | | | | |
| Comparison 7 | 0.3 | | | | x | — |
| Comparison 8 | 0.2 | | | | x | — |
| Comparison 9 | 0.2 | x | x | | | — |

According to Table 3, it was confirmed that for the abrasives (Examples 1 to 5) of this invention, a processing speed (the ground amount per unit time) was fast and no damage was given to parts or objects other than the target to be ground. Also, no destruction of the abrasive or discoloring due to oxidation was found.

Subsequently, an abrasive (Example 6) was manufactured by heat attachment of stearic acid to the abrasive of Example 1 (that is, by coating the abrasive of Example 1 with stearic acid) in the proportions of 0.3 wt % stearic acid to 100 wt % abrasive. Moreover, an abrasive (Example 7) was manufactured by adding and mixing 0.5 wt % anhydrous silica particles (aerosil R812 made by Nippon Aerosil Co., Ltd.) to 100 wt % abrasive (Example 1).

Concerning Examples 1, 6 and 7, a funnel tube of the shape defined by JIS Z2502 (orifice diameter: 5 mm) was used to evaluate the fluidity of each abrasive according to the following standards. Table 4 shows the results.

Very good fluidity as compared with Example 1

Good fluidity as compared with Example 1

Subsequently, concerning Examples 1 and 6, the moisture absorption was evaluated according to the following standard. Table 4 shows the results.

Low moisture absorption as compared with Example 1

TABLE 4

| | | Evaluation | |
|---|---|---|---|
| | | Fluidity | Moisture Absorption |
| Example 1 | No coating or addition | | |
| Example 6 | Coating of stearic acid | | |
| Example 7 | Addition of aerosil powder | | |

According to Table 4, it was confirmed that the abrasive (Example 6) obtained by heat attachment of stearic acid to the surface of the abrasive of Example 1 exhibited much improved fluidity as compared to the abrasive of Example 1. It was also confirmed that the abrasive (Example 7) obtained by adding and mixing anhydrous silica particles to the abrasive of Example 1 exhibited lower moisture absorption than the abrasive of Example 1.

Concerning Embodiment 1, the abrasives containing the components shown in Table 1 have been described. However, without limitation to these abrasives, any abrasive that meets the conditions of (1) true specific gravity of 4 g/cm³ or more, (2) an average particle diameter in the range of 5 μm to 50 μm inclusive, (3) maximum particle size of 100 μm or less, and (4) hardness (HMV) in the range of 110 to 340 inclusive, may be used even if it contains other components.

There may be various kinds of examples of the case where grinding should be performed to make grooves, including the formation of a glass paste layer of a glass substrate sealer for a liquid crystal panel or an organic EL.

(Embodiment 2)

An abrasive manufacturing device and method according to Embodiment 2 of this invention is described below with reference to the relevant drawings.

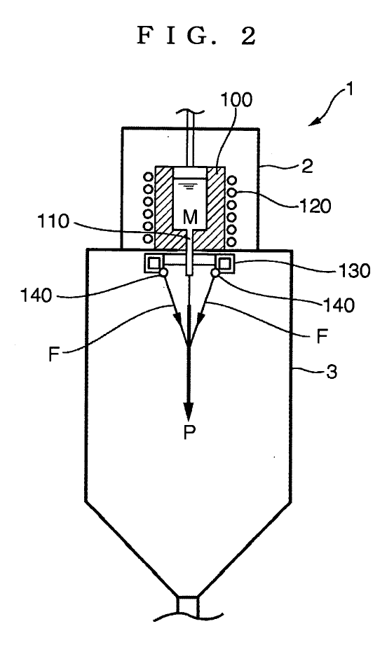

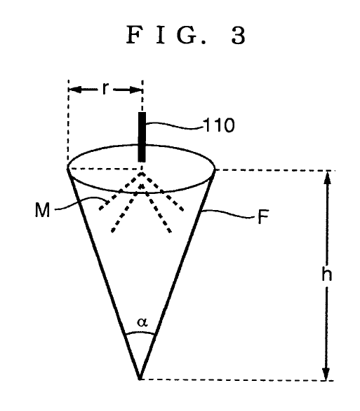

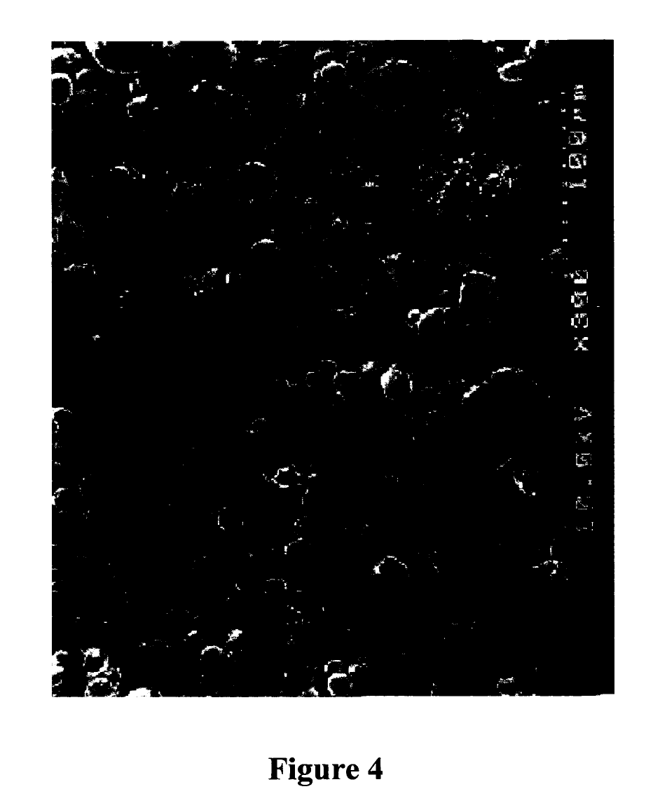

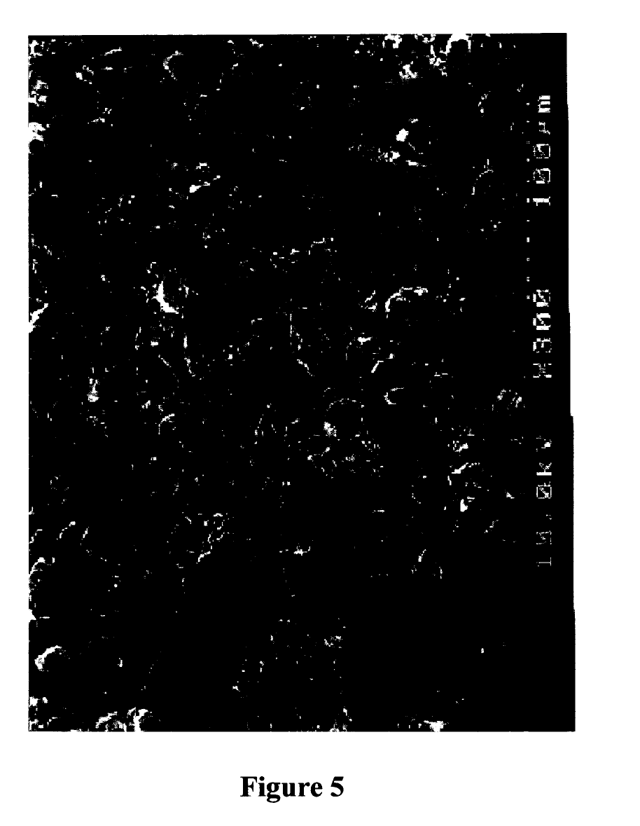

FIG. 2 is a conceptual drawing of a vertical section of an abrasive manufacturing device according to Embodiment 2 of this invention. FIG. 3 is a conceptual drawing of a high-pressure fluid ejected from an atomizer which is a component of the manufacturing device show in FIG. 2. FIG. 4 is a microphotograph of an abrasive (or metal powder) manufactured by the manufacturing device and method according to Embodiment 2 of this invention. FIG. 5 is a microphotograph of a conventional abrasive (or metal powder).

As shown in FIGS. 2 and 3, an abrasive manufacturing device 1 according to Embodiment 2 of this invention comprises a melting chamber 2 and an atomizing chamber 3 positioned below the melting chamber 2.

The melting chamber 2 has a generally cylindrical shape, inside of which there is a tundish 100 for containing molten metal M melted by an induction furnace (not shown in the drawings). This tundish 100 has a generally cylindrical shape. In a generally central area at the bottom of the tundish 100, an ejecting nozzle 110 (a ceramic nozzle with a diameter of several millimeters) is mounted to cause the molten metal M contained in the tundish 100 to pass through the tundish 100 and to eject out toward the atomizing chamber 3. Around the outside surface of the tundish 100, a heating coil 120 as a heater for heating the inside of the tundish 100 is positioned.

The atomizing chamber 3 has a generally cylindrical shape, at the inner top of which a ring-shaped atomizing nozzle 130 is located. A high-pressure fluid is supplied from a high-pressure fluid source (not shown in the drawings) to the atomizing nozzle 130. On the inner surface side of this atomizing nozzles 130, nozzles 140 slanting downwards are positioned in a manner projecting toward the center of the atomizing chamber 3. From these nozzles 140, the high-pressure fluid F is ejected in a manner such that the high-pressure fluid F will form a generally conical shape, which converges downwards, and will surround the molten metal M. These nozzles 140 can be adjusted so that angle α (see FIG. 3) of the vertex of the generally conical shape formed by the ejection of the high-pressure fluid F will be in the range between not less than 10 degrees and less than 30 degrees. Concerning Embodiment 2, the slanting of the nozzles 140 is set so that the angle α of the vertex of the generally conical shape formed by the ejection of the high-pressure fluid F will be 20 degrees.

The atomizing chamber 3 is structured in a manner such that it can be hermetically sealed. The lower end of the atomizing chamber 3 is connected to a container for collecting metal powder P via a valve (not shown in the drawings).

A method for manufacturing the abrasive (metal powder) by using the above-mentioned metal powder manufacturing device 1 is described below.

Concerning Embodiment 2, the angles of the nozzles 140 at the nozzle 130 are adjusted so that the angle β of the vertex of the generally conical shape formed by the ejection of the high-pressure fluid will be 20 degrees. Accordingly, it is possible to secure a wider dispersion area of primary division particles of the molten metal M than a conventional device (when the angle α of the vertex of the generally conical shape is 30 degrees).

The dispersion area of the primary division particles of the molten metal M can be converted to a volume of the generally conical shape formed by the ejection of the high-pressure fluid. Even if the angle α changes, a radius of the generally conical shape is constant (r). Since the height (h) of this generally conical shape is h=r/tan (α/2), the height (h) can be found as follows:

In a case when α=20 degrees, h=r/tan 10 r/0.1763 5.67r

In a case when α=30 degrees, h=r/tan 5 r/0.2679 3.73r

Accordingly, when the angle α is 20 degrees, the height (h) of the generally conical shape is longer than the conventional device (angle α=30 degrees) and it is possible to have a larger volume of the generally conical shape. As a result, it is possible to secure a wider dispersion area of the primary division particles of the molten metal M than the conventional device (angle α of the vertex of the generally conical shape=30 degrees).

This manufacturing device was used to manufacture an abrasive (or metal powder: Example 8) in the following steps.

The molten metal M made by melting raw materials of the components shown in Table 5 (as components of Example 8) was first poured into the tundish 100 of the manufacturing device 1 shown in FIG. 2. Then the heating coil 120 was used to heat the molten metal M poured into the tundish 100 up to approximately 1650.

Subsequently, at the same time as the molten metal M was ejected from the ejecting nozzle 110 mounted at the tundish 100 to cause the molten metal M to pass through the tundish 100 downwards, the nozzles 140 of the atomizing nozzles 130 ejected the high-pressure fluid F (water in Embodiment 2) at a pressure between 10 and 100 Mpa inclusive and with an atomizing amount of 0.3 to 0.8 m³/min onto the molten metal M so that the high-pressure fluid F will form a generally conical shape (the angle α of the vertex of the generally conical shape=20 degrees), which converges downwards, and will surround the molten metal M.

This ejection of the high-pressure fluid F powdered the molten metal M, thereby obtaining the abrasive (or metal powder: Example 8).

TABLE 5

| | C | Si | Mn | P | S | Cr | Al | Ti | Fe |
|---|---|---|---|---|---|---|---|---|---|
| Ex. 8 | 0.060 | 0.83 | 0.73 | 0.017 | 0.006 | 12.51 | 0.01 | 0.01 | Bal. |
| | to | | | | | | | | |
| | 0.070 | | | | | | | | |
| Comp. | 0.050 | 1.17 | 0.81 | 0.018 | 0.002 | 19.04 | 2.96 | 0.31 | Bal. |
| 10 | | | | | | | | | |

For comparison purposes, the molten metal made by melting raw materials of the components shown in Table 5 (as components of Comparison 10) was used, and the method similar to that of Example 8, except for the conditions described below, was employed to powder the molten metal, thereby obtaining the metal powder (Comparison 10).

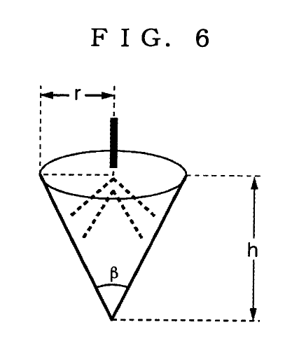

The manufacturing device used for Comparison 10 did not include the heating coil for heating the tundish and, therefore, the molten metal contained in the tundish was not heated. Moreover, the nozzles at the atomizing nozzle for ejecting the high-pressure fluid were adjusted so that angle β (see FIG. 6) of the vertex of the generally conical shape formed by the ejection of the high-pressure fluid would be 30 degrees. The high-pressure fluid was ejected onto the molten metal so that the angle β of the vertex of the generally conical shape would be 30 degrees.

Concerning Example 8 and Comparison 10, the temperature ( ) of the molten metal at the time of atomization was measured. Table 6 shows the results.

TABLE 6

| | Temperature of Molten Metal ( ) |
|---|---|
| Example 8 | 1,630 to 1,680 |
| Comparison 10 | 1,550 to 1,600 |

According to Table 6, it was confirmed that the temperature of the molten metal increased by approximately 80.

In order to compare the shapes of the particles of the metal powder obtained in Example 8 and Comparison 10, microphotographs of these particles were taken. FIG. 4 shows a microphotograph of the abrasive (or metal powder) of Example 8, while FIG. 5 shows a microphotograph of the abrasive (or metal powder) of Comparison 10.

According to FIGS. 4 and 5, it has been confirmed that more particles of the abrasive (or metal powder) of Example 8 are formed as single grains, that is, these particles are less agglomerated, than the abrasive (or metal powder) of Comparison 10. Moreover, the shapes of the particles of Example 8 are close to spherical.

The hardness (HVM) and the tap density of the abrasives (or metal powder) obtained in Example 8 and Comparison 10 were measured in the following manner. Table 7 shows the results.

The tap density was measured with a tool made by Kuramochi Kagaku Kikai Seisakusho and by a method specified by Japan Powder Metallurgy Association (JPMA) standards P 08 “Tap Density Testing Method for Metal Powder.”

TABLE 7

| | Hardness (HMV) | |
|---|---|---|
| | (Average value of n = 10) | Tap Density (g/cm³) |
| Example 8 | 327 | 4.30 to 4.80 |
| Comparison 10 | 301 | 3.90 to 4.15 |

According to Table 7, it has been confirmed that as compared with the abrasive (or metal powder) of Comparison 10, the abrasive (or metal powder) of Example 8 has a higher tap density. As a result, it has been confirmed that the creation of single grains is more progressive with regard to the abrasive of Example 8 and the shapes of its particles are closer to spherical.

The method similar to that of Example 8, except for the use of the molten metal made by melting the raw materials of the same components as those of Comparison 10, was then employed to powder the molten metal, thereby obtaining an abrasive (or metal powder: Example 9).

For comparison purposes, metal powder (or abrasive) (Comparison 11) was obtained by powdering the molten metal by the method similar to that of Example 8, except that the molten metal made by melting the raw materials of the components of Comparison 10 was used and that the nozzles at the atomizing nozzle for ejecting the high-pressure fluid were adjusted so that angle β (see FIG. 6) of the vertex of the generally conical shape formed by the ejection of the high-pressure fluid would be 40 degrees.

Subsequently, the tap density of the metal powder obtained in Example 9 and Comparison 11 was measured by the method similar to that described above. Table 8 shows the results.

TABLE 8

| | Atomizing | Tap | |
|---|---|---|---|
| | Angle | Density (g/cm³) | Powder Hardness (HMV) |
| Example 9 | 20 degrees | 4.50 | 327 |
| Comparison 11 | 40 degrees | 4.00 | 312 |

According to Table 8, it has been confirmed that as compared with the abrasive (or metal powder) of Comparison 11, the abrasive (or metal powder) of Example 9 has a higher tap density. As a result, it has been confirmed that the creation of single grains is more progressive with regard to the abrasive of Example 9 and the shapes of its particles are closer to spherical.

As described above, the abrasive of this invention can exhibit excellent grinding power without damaging parts or objects other than the target to be ground, and can also prevent narrow crevices (such as grooves) from being clogged with the abrasive when such crevices are being ground. As a result, it is possible to grind a work piece in a short time in a manner that achieves high quality, and improves productivity. Since the abrasive of this invention suffers almost no change of quality, it can be recycled and thereby contribute to cost reduction and environmental preservation.

Moreover, regarding the abrasive of this invention, there is the high surface tension of the molten metal, which is the raw material. Accordingly, it is possible to promote the creation of single grains of the metal powder. Therefore, it is possible to demonstrate excellent blast effect and productivity in the blast step.

Furthermore, the abrasive manufacturing method and device of this invention can secure a wide primary dispersion area of the molten metal caused by the ejection of the high-pressure fluid. Accordingly, when the abrasive (or metal powder) is generated by a decompression effect of the ejected high-pressure fluid, it is possible to strengthen the diffusion of primary division particles and to prevent agglomeration of the obtained abrasive. As a result, first particles are barely generated due to division of agglomerated particles of the abrasive in the blast step, thereby making it possible to improve the blast effect and the productivity in the blast step.

I claim:

1. An abrasive ejected onto a work piece to grind and process the work piece, the abrasive being composed of an inorganic powder that meets all the following conditions:
(1) its true specific gravity is 4 g/cm³ or more;
(2) its average particle diameter is from 5 μm to 50 μm inclusive;
(3) its maximum particle size is 100 μm or less;
(4) its hardness (HMV) is from 110 to 340 inclusive.

2. The abrasive according to claim 1, wherein the average particle diameter of the inorganic powder is from 10 μm to 30 μm inclusive.

3. The abrasive according to claim 1 or 2, wherein the maximum particle size of the inorganic powder is 80 μm or less.

4. The abrasive according to claim 1, wherein the inorganic powder is metal powder.

5. The abrasive according to claim 4, wherein the principal component of the metal powder is iron or an iron-based alloy and the metal powder contains not more than 0.1 wt % aluminum and not more than 0.1 wt % titanium.

6. The abrasive according to claim 5, wherein the metal powder is stainless steel containing not less than 8 wt % chromium.

7. The abrasive according to claim 5, wherein the metal powder is stainless steel containing not more than 1.5 wt % boron.

8. The abrasive according to claim 1, wherein the tap density of the metal powder is from 4.3 g/cm³ to 4.8 g/cm³ inclusive.

9. The abrasive according to claim 1, wherein 0.01 wt % to 5 wt % of a substance providing fluidity and resistance to moisture absorption is mixed in 100 wt % of the inorganic powder.

10. The abrasive according to claim 1, wherein a substance providing fluidity and resistance to moisture absorption is attached to a part of or the entire surface of the inorganic powder in the proportions of 0.01 wt % to 5 wt % of the substance to 100 wt % of the inorganic powder.

11. The abrasive according to claim 1, wherein the work piece is a paste layer formed on a substrate.

12. An abrasive manufacturing method comprising the steps of:
causing molten metal contained in a tundish including an ejecting nozzle to eject from the ejecting nozzle; and
ejecting a high-pressure fluid onto the molten metal ejected from the ejecting nozzle in such a manner that the high-pressure fluid will form a generally conical shape, which converges downwards, and will surround the molten metal, thereby powdering the molten metal;
wherein the angle of a vertex of the generally conical shape that is formed by ejection of the high-pressure fluid is set between not less than 10 degrees and less than 30 degrees.

13. The abrasive manufacturing method according to claim 12, wherein the angle of a vertex of the generally conical shape that is formed by ejection of the high-pressure fluid is set from 15 degrees to 25 degrees inclusive.

14. The abrasive manufacturing method according to claim 12, wherein the angle of a vertex of the generally conical shape that is formed by ejection of the high-pressure fluid is set to 20 degrees.

15. The abrasive manufacturing method according to any one of claims 12 to 15, further comprising the step of heating the tundish.

16. The abrasive manufacturing method according to claim 15, wherein the tundish is heated so that the temperature of the molten metal ejected from the ejecting nozzle will be between 1600 and 1700 inclusive.

17. The abrasive manufacturing method according to claim 12, wherein as the molten metal, a raw material is used whose principal component is iron or an iron-based alloy, and which contains carbon in the range of 0.060 wt % to 0.070 wt % inclusive, and to which no aluminum or titanium is added.

18. An abrasive manufacturing device comprising:
a tundish for containing molten metal;
an ejecting nozzle mounted on the tundish to cause the molten metal contained in the tundish to eject out; and
an atomizing nozzle for ejecting a high-pressure fluid onto the molten metal ejected from the ejecting nozzle in such a manner that the high-pressure fluid will form a generally conical shape, which converges downwards, and will surround the molten metal;
wherein the atomizing nozzle causes a high-pressure fluid to eject so that the angle of a vertex of the generally conical shape that is formed by ejection of the high-pressure fluid will be between not less than 10 degrees and less than 30 degrees.

19. The abrasive manufacturing device according to claim 18, wherein the atomizing nozzle causes the high-pressure fluid to eject so that the angle of a vertex of the generally conical shape that is formed by ejection of the high-pressure fluid will be from 15 degrees to 25 degrees inclusive.

20. The abrasive manufacturing device according to claim 18, wherein the atomizing nozzle causes the high-pressure fluid to eject so that the angle of a vertex of the generally conical shape that is formed by ejection of the high-pressure fluid will be 20 degrees.

21. The abrasive manufacturing device according to any one of claims 18 to 20, further comprising a heater for heating the tundish.

22. The abrasive manufacturing device according to claim 21, wherein the heater heats the tundish so that the temperature of the molten metal ejected from the ejecting nozzle will be between 1600 and 1700 inclusive.

23. An abrasive manufactured by an abrasive manufacturing method comprising the steps of:
causing molten metal contained in a tundish including an ejecting nozzle to eject from the ejecting nozzle; and
ejecting a high-pressure fluid onto the molten metal ejected from the ejecting nozzle in such a manner that the high-pressure fluid will form a generally conical shape, which converges downwards, and will surround the molten metal, thereby powdering the molten metal;
wherein the angle of a vertex of the generally conical shape that is formed by ejection of the high-pressure fluid is set between not less than 10 degrees and less than 30 degrees.

24. An abrasive manufactured by an abrasive manufacturing device comprising:
a tundish for containing molten metal;
an ejecting nozzle mounted on the tundish to cause the molten metal contained in the tundish to eject out; and
an atomizing nozzle for ejecting a high-pressure fluid onto the molten metal ejected from the ejecting nozzle in such a manner that the high-pressure fluid will form a generally conical shape, which converges downwards, and will surround the molten metal;
wherein the atomizing nozzle causes the high-pressure fluid to eject so that the angle of a vertex of the generally conical shape that is formed by ejection of the high-pressure fluid will be between not less than 10 degrees and less than 30 degrees.
